(19) United States
(12) Patent Application Publication
(10) Pub. No.: US 2019/0277995 A1
(43) Pub. Date: Sep. 12, 2019

(54) METAMATERIAL ELECTROMAGNETIC SENSORS FOR WELL LOGGING MEASUREMENTS

(71) Applicant: HALLIBURTON ENERGY SERVICES, INC., Houston, TX (US)

(72) Inventors: Ahmed E. FOUDA, Houston, TX (US); Burkay DONDERICI, Houston, TX (US)

(73) Assignee: HALLIBURTON ENERGY SERVICES, INC., Houston, TX (US)

(21) Appl. No.: 16/415,849

(22) Filed: May 17, 2019

Related U.S. Application Data
(63) Continuation of application No. 15/316,813, filed on Dec. 6, 2016, now abandoned.

(51) Int. Cl. G01V 3/28

(52) U.S. Cl. CPC G01V 3/28

(57) ABSTRACT

Metamaterials are used in well logging measurement tools to position-shift and size-scale antennas such that they can be placed very close to the outer perimeter of the tool, which can improve azimuthal sensitivity and vertical resolution. Antennas of an azimuthal pipe inspection or induction-based borehole imaging tool can be placed with minimal stand-off against a borehole wall. Use of such metamaterials can improve the resolution of logs or images that are obtained by such tools. The metamaterials also can be used to effectively centralize radial coils. Disclosed implementations of metamaterials can be used with gradient ranging tools to effectively increase the spacing between ranging antennas. Increased spacing can maximize the signal levels with respect to noise, without producing distortions that are observed with the inclusion of magnetic materials.

### FIELD

The subject matter herein generally relates to sensors for use in well logging applications such as induction-based borehole imaging and azimuthal pipe inspection tools. In particular, the disclosure relates to the use of metamaterials in the design of such sensors to compensate for the restrictive geometries exhibited by existing tools.

### BACKGROUND

In induction-based borehole imaging and azimuthal pipe inspection tools, it is usually desirable to place the sensors as close as possible to the outer perimeter of the tool to improve azimuthal sensitivity. However, the minimum achievable stand-off is determined by the finite cross-section of the sensor. In principle, the stand-off cannot be smaller than the radius of the sensor. Likewise, it is desirable to squeeze the sensor in the axial direction to improve vertical resolution. Again, this is limited by the physical dimensions of the coil windings.

In a similar sense, the spacing between coils in gradient ranging tools is determined by the geometry of the coils. In these tools, it is desirable to maximize the aperture spanned by the ranging coils (in other words, the spacing between the coils) so as to improve the gradient stability in the presence of measurement noise. Conventional ways to expand the effective aperture include inserting high-k dielectric materials, (materials having a high dielectric constant), or high-p magnetic materials, (materials having a high magnetic constant), between the coils. However, the intrinsic impedances of such high index of refraction materials are essentially different from the impedances of the operating ambient background. This impedance difference introduces signal distortions that must be compensated.

### BRIEF DESCRIPTION OF THE DRAWINGS

Implementations of the present technology will now be described, by way of example only, with reference to the attached figures, wherein:

FIGS. 1A-1D are diagrams illustrating the principles of transformation optics which are used in the design of metamaterials;

FIGS. 2A-2B are diagrams illustrating the composition of conventional materials versus metamaterials;

FIG. 3A is a diagram of a multi-cylinder split ring resonators SRR metamaterial;

FIG. 3B is a diagram of a directive metamaterial antenna;

FIG. 4 is a diagram of a negative index of refraction (NIR) lens in which double negative (DNG) metamaterial lens is employed;

FIGS. 5A-5B are diagrams of a capacitively loaded metamaterial SNG flat lens;

FIG. 5C shows a capacitively loaded metamaterial single negative SNG cylindrical rolled-up lens;

FIG. 6 is a diagram of a DNG chiral metamaterial;

FIGS. 7A-7B are diagrams illustrating a decentralized antenna design in accordance with an embodiment of the present disclosure;

FIGS. 8A-8B are graphs illustrating the coordinate transformation of the embodiment in FIG. 7;

FIGS. 9A-9D are diagrams illustrating a decentralized antenna design in accordance with another embodiment of the present disclosure;

FIGS. 10A-10B are diagrams illustrating a decentralized and scaled antenna design in accordance with yet another embodiment of the present disclosure;

FIGS. 11A-11B are graphs illustrating the coordinate transformation of the design in FIG. 10;

FIGS. 12A-12B are diagrams illustrating a design of an antenna for borehole casing inspection in accordance with another embodiment of the present disclosure;

FIGS. 13A-13B are diagrams illustrating a design of a borehole imaging tool with a backbone in accordance with another embodiment of the present disclosure;

FIGS. 13C-13D are graphs illustrating the coordinate transformation of the design in FIGS. 13A-13B;

FIGS. 14A-14B are diagrams illustrating a design of a borehole imaging tool with a triaxial coil in accordance with another embodiment of the present disclosure;

FIGS. 14C-14D are graphs illustrating the coordinate transformation of the design in FIGS. 14A-14B;

FIGS. 15A-15B are diagrams illustrating a design of a borehole imaging tool that collapses any internally placed arbitrary source to a centralized point source in accordance with another embodiment of the present disclosure;

FIGS. 15C-15D are graphs illustrating the coordinate transformation of the design in FIGS. 15A-15B;

FIGS. 16A-16B are diagrams illustrating a design of a gradient range measuring tool in accordance with another embodiment of the present disclosure;

FIG. 17 is a diagram illustrating an example environment for a tool employing metamaterial lens in accordance with the principles of the present disclosure; and

FIG. 18 is a diagram illustrating an example wireline environment for a tool employing metamaterial lens in accordance with the principles of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

In the following description, terms such as “upper,” “upward,” “lower,” “downward,” “above,” “below,” “downhole,” “uphole,” “longitudinal,” “lateral,” and the like, as used herein, are descriptive of a relationship with, and are used with reference to, the bottom or furthest extent of the surrounding wellbore, even though the wellbore or portions of it may be deviated or horizontal. Correspondingly, the transverse, axial, lateral, longitudinal, radial, etc., orientations shall mean orientations relative to the orientation of the surrounding wellbore or wellbore tool in question. Additionally, the non-limiting embodiments within this disclosure are illustrated such that the orientation is such that the right-hand side is down hole compared to the left-hand side.

Several definitions that apply throughout this disclosure will now be presented.

The term “coupled” is defined as connected and/or attached, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicate that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder.

The term “radially” means substantially in a direction along a radius of the object, even if the object is not exactly circular or cylindrical. The term “axially” means substantially along a direction of the axis of the object. If not specified, the term axially is such that it refers to the longer axis of the object.

“Processor” as used herein is an electronic circuit that can make determinations based upon inputs and is interchangeable with the term “controller”. A processor can include a microprocessor, a microcontroller, and a central processing unit, among others. While a single processor can be used, the present disclosure can be implemented over a plurality of processors, including local controllers in a tool or sensors along the drill string.

The present disclosure is described in relation to metamaterials. Metamaterials are artificially-engineered composites that inherit their electrical properties from the geometry and arrangement of their constituting unit cells. Metamaterials can be realized in many different ways depending on the operation frequency. Metamaterials designed according to transformation optics rules exhibit iso-impedance; in other words metamaterials have substantially the same intrinsic impedance as the background medium, and therefore introduce substantially no spurious reflections, as opposed to more conventional materials. In addition, metamaterials can be designed to control electromagnetic fields in ways not achievable by conventional materials.

The metamaterial realization techniques described herein employ resonant structures. This makes the metamaterial highly dispersive and lossy when operated near resonance. This also means that a metamaterial with given properties can only be designed to operate at a single frequency. The use of metamaterials also extends to quasi-static and DC applications, such as for a DC diamagnetic metamaterial, for a DC magnetic cloak, and for a DC electric concentrator. Negative index of refraction metamaterial can also be used in enhanced material investigation tools. The metamaterial focuses electromagnetic energy for deeper depth of investigation yielding more efficient use of the available power. One use includes an electromagnetic measurement tool within a borehole that measures formation properties associated with oil exploration.

According to the present disclosure, metamaterials can be advantageous in well logging electromagnetics for a number of reasons. Metamaterials enable narrow band, single-frequency operation of most tools relevant to this disclosure. Metamaterials accommodate the regular cylindrical geometry of most tools relevant to this disclosure. The generally low operating frequencies of such tools enhance the application of the homogenization condition described above. Furthermore, electric and magnetic fields are decoupled in many tools relevant to this disclosure; this decoupled relationship facilitates the realization of metamaterials using a reduced set of material properties.

Another reason that metamaterials can be advantageous in well logging electromagnetics is that the predefined field polarization of most tools relevant to this disclosure facilitates the design of an appropriate metamaterial using a reduced set of parameters. Additionally, if SNG and DNG are not needed, non-resonant, low loss metamaterials operating at wavelengths much longer than the unit cell can be designed.

According to the present disclosure, the constraining geometries in well logging can be alleviated by introducing appropriate spatial transformations realized using metamaterials. In accordance with the present disclosure, metamaterials are designed to achieve position shifting and scaling of electromagnetic sensors in wellbores. This alters the effective location and effective size of the electromagnetic sensors, making them appear smaller and/or in a different position than their respective actual size and actual location. This is applicable to any electromagnetic sensor used in wellbores, for example electromagnetic coils.

In one embodiment of the disclosure, the stand-off between the sensors and the tool body in azimuthal pipe inspection and induction-based borehole imaging tools is minimized through the use of position shifting metamaterials. In particular, the metamaterial “shrinks” the actual sensors into down-scaled equivalents that are then virtually shifted towards the outer perimeter of the tool. This serves to increase both azimuthal and vertical resolutions of inspection and imaging tools. In another embodiment, transformation metamaterial is used to effectively displace the tool backbone allowing radial coils to be effectively positioned at the center of the tool. In this way, a centralized triaxial coil can be realized using three decentralized coils. In yet another embodiment, the spacing between coils in gradient ranging tools is expanded by the use of metamaterials. Such expansion increases the stability of the measured gradient to noise and other measurement uncertainties.

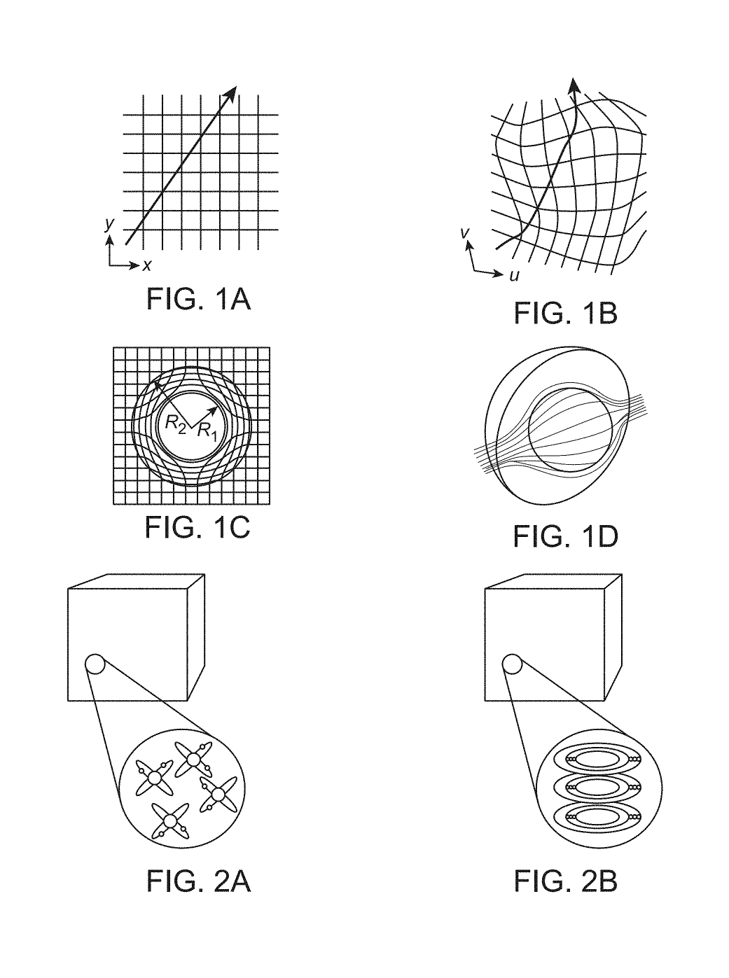

FIGS. 1A-1D conceptually illustrate metamaterials. FIG. 1A shows an original two-dimensional space defined by a grid. If it is assumed that the underlying grid is “elastic” and can be transformed to achieve certain field shaping as shown in FIG. 1B, the form-invariance of Maxwell's equations under coordinate transformation means that such transformations can be interpreted as if the original medium within the transformed space is replaced by a generally anisotropic and inhomogeneous medium. Materials having such properties may not exist in nature and therefore are referred to as “metamaterials.” A well-known application of transformation optics by metamaterials is invisibility cloaking. As shown in FIG. 1C, the original grid space is transformed to create an enclosure in the inner region (ρ<R₁) while maintaining the original grid in the outer region (ρ>R₂.) The region where (R₁<ρ<R₂) is the region in which one or more metamaterial is used to mimic the illustrated grid deformation. This deformation allows light rays to be smoothly steered around the enclosure in the inner region, rendering invisible any object placed in the enclosure. A three-dimensional depiction of such cloaking is shown in FIG. 1D.

Mathematically, transformation optics can be described using Maxwell's equations. In the original space, we have the equations:

∇×E=−jωμH

∇×H=jωϵE+Jₛ (1)

Given the following spatial transformation in cylindrical coordinates:

ρ′=ρ′(ρ,ϕ,Z)

ϕ′=ϕ′(ρ,ϕ,Z)

Z′=Z′(ρ,ϕ,Z)

Maxwell's equations take the following form, as they are form-invariant under coordinate transformation:

∇′×E′=−jωμ′H′

∇′×H′=jωϵ′E′+J′ₛ (3)

where

$$\begin{matrix}{μ}^{′} = \frac{A μ {A}^{T}}{\vert A \vert} \\ {ϵ}^{′} = \frac{A ϵ {A}^{T}}{\vert A \vert} \\ {J}_{s}^{′} = \frac{A {J}_{s} \vert {J}_{s} \vert}{\vert {AJ}_{s} \vert} \\ and & ( 4 ) \\ A = [ \begin{matrix}\frac{\partial {ρ}^{′}}{\partial ρ} & \frac{\partial {ρ}^{′}}{ρ \partial φ} & \frac{\partial {ρ}^{′}}{\partial z} \\ \frac{{ρ}^{′} \partial {φ}^{′}}{\partial ρ} & \frac{{ρ}^{′} \partial {φ}^{′}}{ρ \partial φ} & \frac{{ρ}^{′} \partial {φ}^{′}}{\partial z} \\ \frac{\partial {z}^{′}}{\partial ρ} & \frac{\partial {z}^{′}}{ρ \partial φ} & \frac{\partial {z}^{′}}{\partial z}\end{matrix} ] & ( 5 )\end{matrix}$$

is the Jacobian matrix of the transformation.

The above equations (4) represent the material properties and the equivalent current source that should be used to realize the prescribed coordinate transformation. Transformations that preserve grid continuity across the transformed space boundary result in reflectionless, iso-impedance metamaterials. Another class of transformations exists, called embedded transformations, in which the grid continuity is broken and therefore reflectionless transmission across the metamaterial/background medium interface is not guaranteed. However, embedded transformations provide higher degrees of flexibility for manipulating fields outside the metamaterial device, and can be designed in such a way to minimize spurious reflections.

Thus, as conceptually shown in FIG. 2A, while conventional materials attain their macroscopic properties from the chemical composition of their constituting atoms, metamaterials as conceptually shown in FIG. 2B attain their macroscopic properties from their artificially engineered constituting unit cells. Metamaterials have been realized in many different ways depending on the application and frequency of operation. Examples of metamaterials summarized below demonstrate their practical feasibility in the current applications.

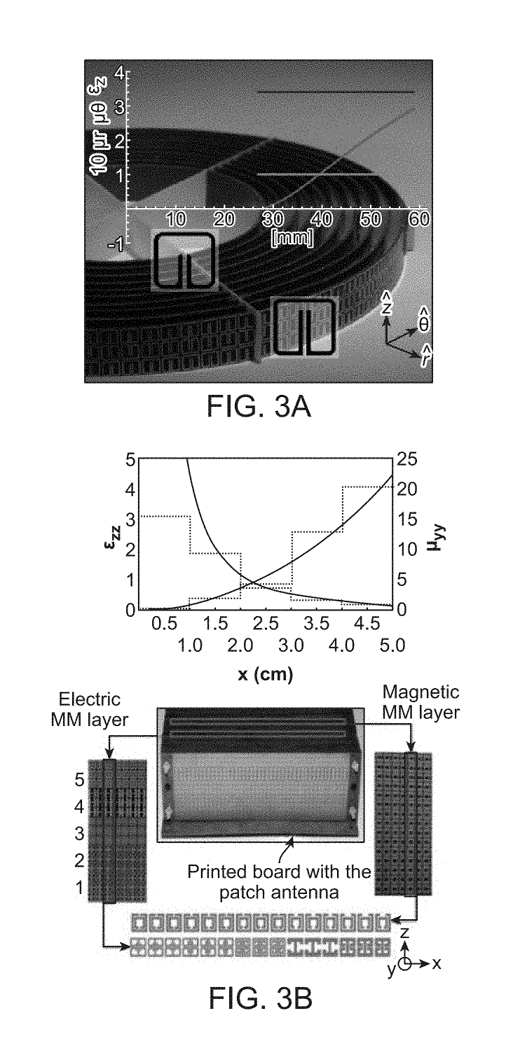

FIG. 3A shows a metamaterial constructed in the form of concentric cylinders having split ring resonators (SRRs) printed thereon. A two-dimensional invisibility cloak requires the radial component of the permeability tensor (μᵣᵣ) to vary radially as shown in the inset of FIG. 3A. The dimensions of the SRRs are adjusted in each cylinder to achieve the required profile. In order to describe the assembly of SRRs with effective macroscopic material properties, the dimension of the unit cell must be much smaller than the desired operating wavelength, which is known in the art as the homogenization condition. Nevertheless, the dimension of the SRR must be large enough to resonate at or near the operating frequency.

FIG. 3B shows an example metamaterial wherein a directive antenna is realized using alternating electric and magnetic metamaterial layers. The electric layers realize the shown discrete ϵ_{zz} profile using five sets of electric-LC (ELC) resonators. The magnetic layers realize the shown discrete μ_{yy} profile using SRRs.

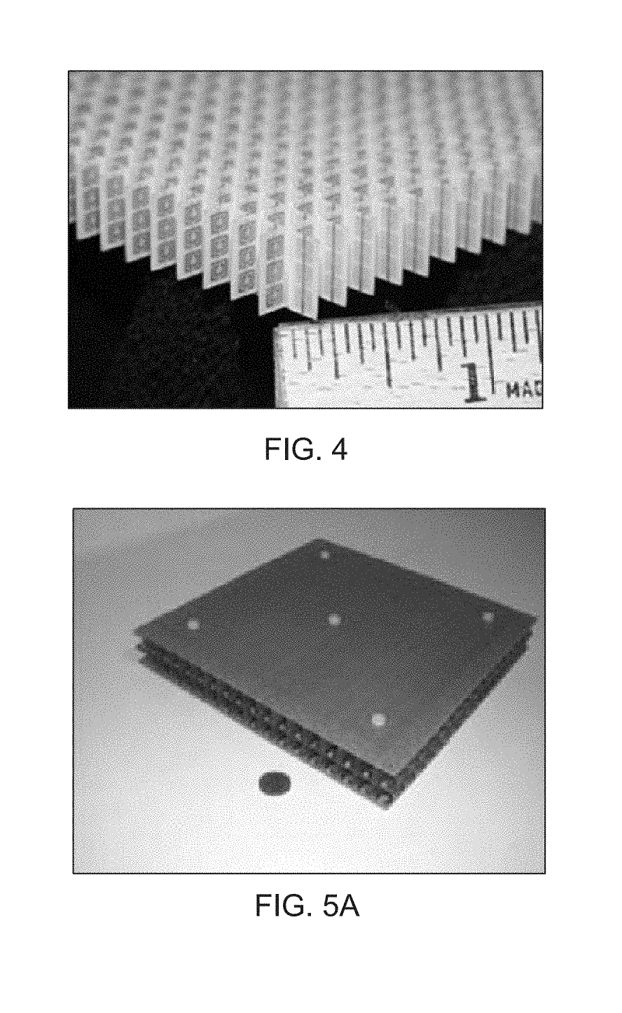

Another example metamaterial construct is shown in FIG. 4. This figure illustrates a negative index of refraction (NIR) lens, in which double negative (DNG) metamaterials are used. Negative permeability is realized using SRRs, whereas negative permittivity is realized using thin wires.

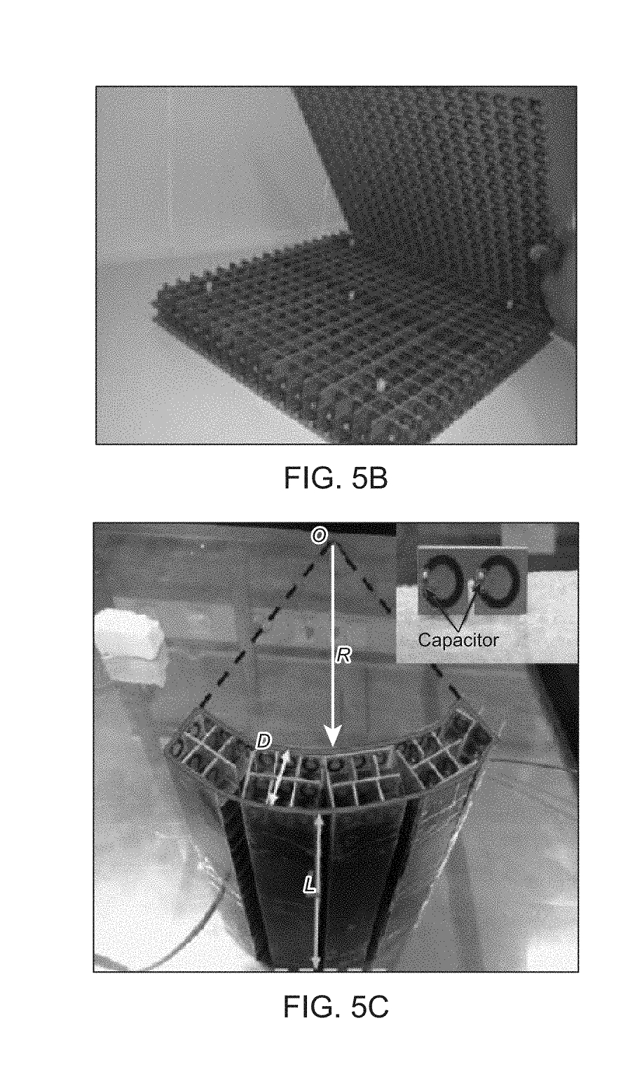

At lower operating frequencies, the dimensions of the SRRs and ELCs which are required in order to resonate at the operating frequency become prohibitively large for practical implementation. For such frequencies, lumped components can be used to achieve resonance without increasing the unit cell size. An example of single negative (SNG) lenses is shown in FIGS. 5A-5C, wherein FIG. 5A shows a flat SNG lens in its operative configuration, FIG. 5B shows the internal capacitor unit cell structure and FIG. 5C shows a cylindrical rolled-up SNG lens. SNG lenses have been used to enhance the sensitivity and spatial resolution of RF coils in magnetic resonance imaging (MRI) systems.

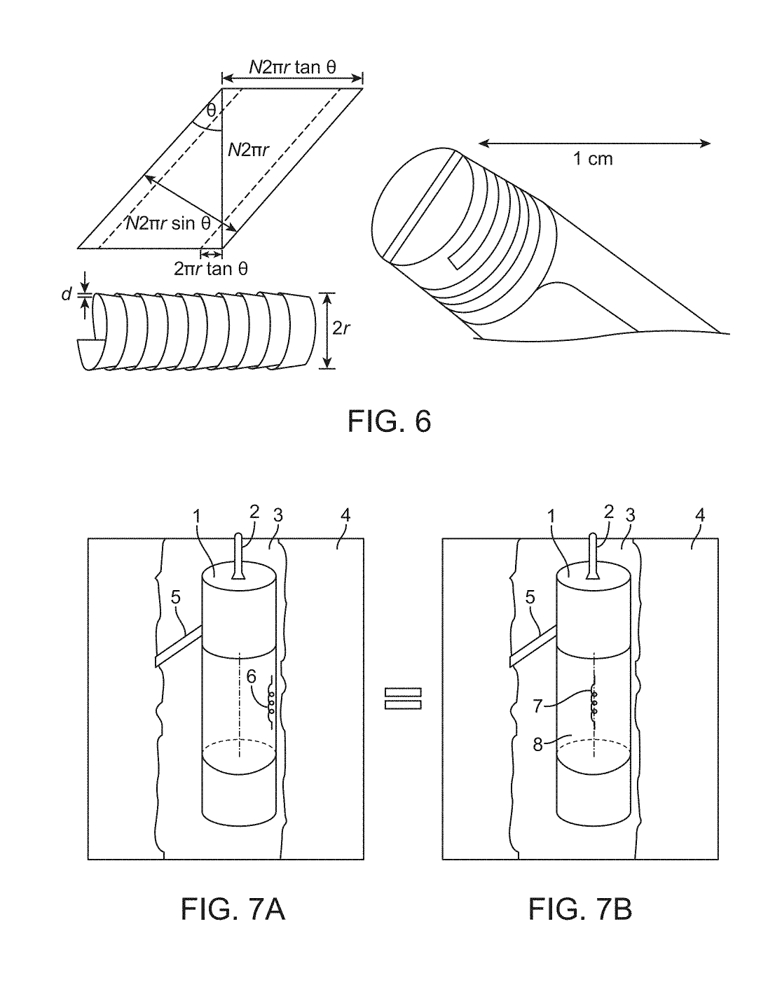

FIG. 6 shows an example of an alternative design of DNG metamaterials involving chiral materials. A chiral metamaterial is constructed of insulated metal strips wound in a helix shape, with the individual helixes stacked in a three-dimensional (3-D) arrangement to form an isotropic DNG structure. The unit cells (in other words, chiral helixes) can have internal resonances with dimensions on the order of 1/1000 (one thousandth) of the operating wavelength. This characteristic is particularly important in the design of metamaterials operating at very low frequencies (in other words, quasi-static metamaterials).

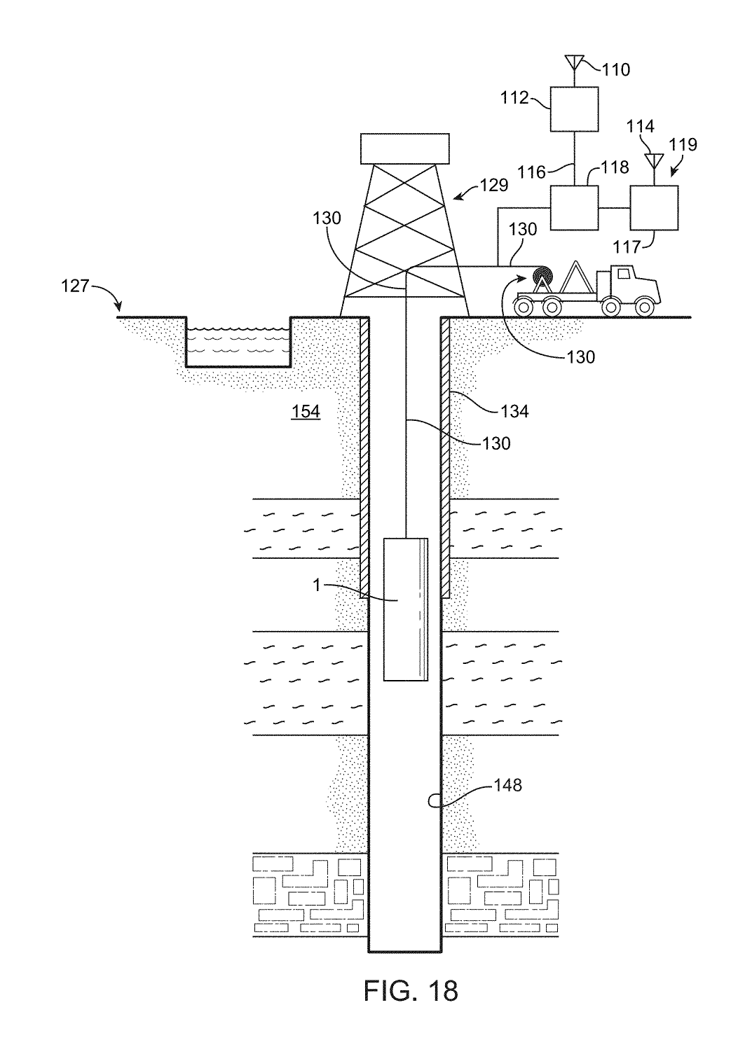

FIGS. 7A and 7B show one embodiment of the disclosure in the form of an induction-based borehole imaging tool. FIG. 7A shows the desired virtual design. A tool having a tool body 1 is inserted into a borehole 3 of a formation 4 and relatively positioned using, for instance, a deployable arm 5. A conveyance 2 is centrally disposed relative to the tool body 1 and upon which the tool body 1 can be suspended. The conveyance 2 can be a wireline, toolstring, coiled tubing, slickline, cables, E-line, or the like (see FIG. 18 regarding an exemplary wireline conveyance). An electromagnetic sensor, namely, eccentric coil 6 is desirably disposed adjacent to the borehole wall. It is desirable to reduce the stand-off between the coil 6 and the borehole walls to improve azimuthal resolution. In implementation, however, the restrictive dimensions of such a tool render such configuration infeasible. Using the transformation optic principles of metamaterials, as shown in FIG. 7B, an actual electromagnetic sensor, namely, concentric coil 7 is embedded in a metamaterial 8. In at least one embodiment within this disclosure, metamaterial 8 can be located in a moveable pad which is coupled to the tool via a deployable arm 5. The metamaterial 8 is designed such that the electromagnetic fields produced by the concentric coil 7 outside the tool body are identical to fields that would be produced by the eccentric coil 6 of FIG. 7A. Accordingly, the use of the metamaterial 8 alters the effective location of the coil 7 so that although actually being located near the middle portion of the tool body 1 as shown in FIG. 7B, it produces magnetic fields as if it were located the periphery of the tool body as shown in FIG. 7A.

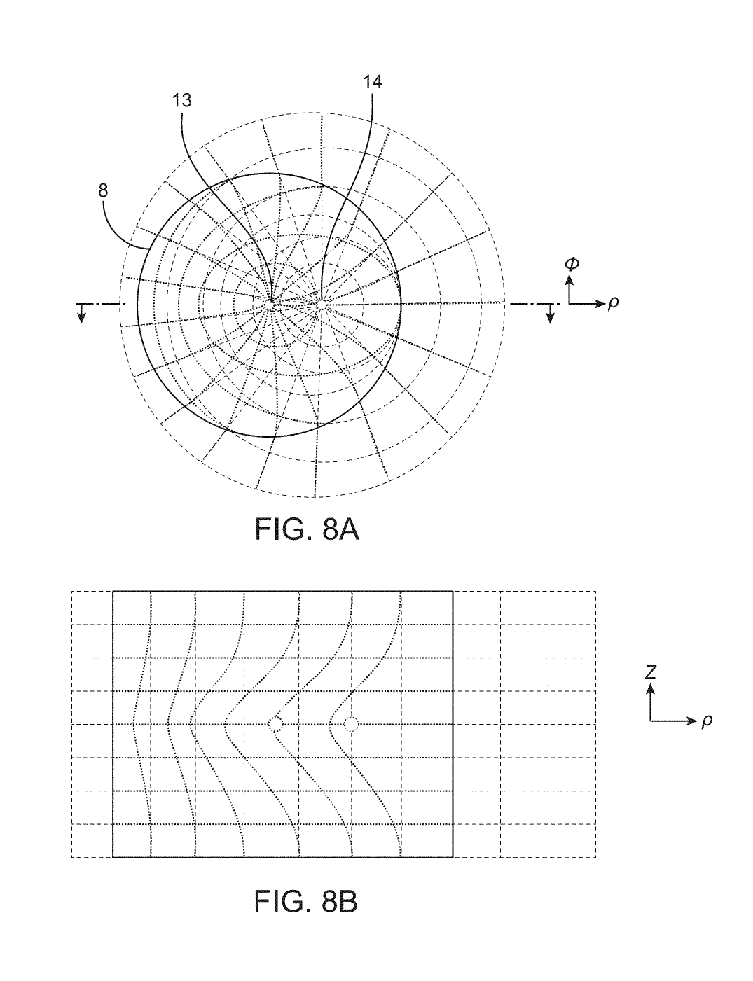

One possible coordinate transformation is shown in FIGS. 8A and 8B. As shown, the grid is kept intact outside the metamaterial, indicating that the fields produced by the embedded concentric coil are identical to fields produced by an eccentric coil embedded in an ambient medium. The transformation involves both source and material transformations. The moments of the concentric and (virtual) eccentric coils are related through equation (4) above. A typical operating frequency range of this tool is from 250 Hz to 10 GHZ, which lies within the range of practical implementation of metamaterials. Accordingly, the actual source 13 placed at an arbitrary position is altered such that its effective location is changed to an effective centralized point source 14 as shown in FIG. 8A.

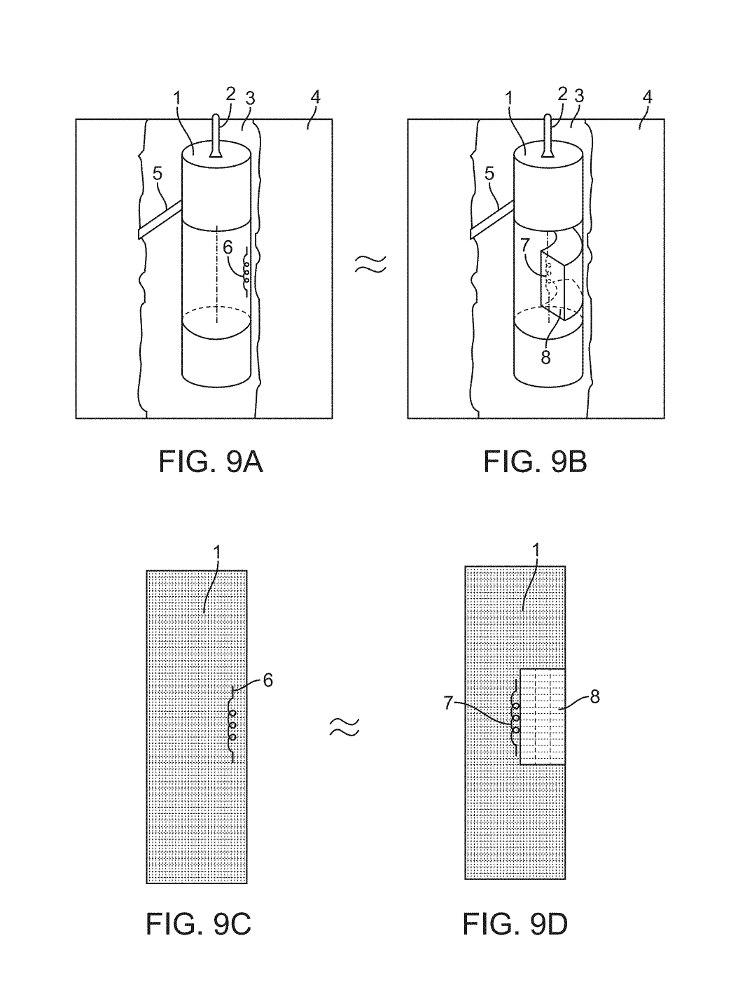

FIGS. 9A-9D show an alternate embodiment of the tool of FIG. 7, wherein the concentric coil 7 is placed outside a metamaterial pad 8 that shrinks the space between the coil and the outer perimeter of the tool body 1. By shrinking the space between the coil 7 and the outer perimeter of the tool body 1, the effective location of the coil 7 is altered such that although its actual location is near the center of the tool body, its virtual position is closer to the perimeter of the tool body 1. In this case, the continuity of grid lines across the top and bottom faces of the metamaterial is broken, which causes signal distortions near those faces. Nevertheless, this embodiment has the advantage that the coil does not need to be embedded inside the metamaterial, which provides more design freedom in realizing the metamaterial. Moreover, signal distortions at or near the interface of the metamaterial and the tool body can be neglected, since high resolution shallow measurements are of interest in this application.

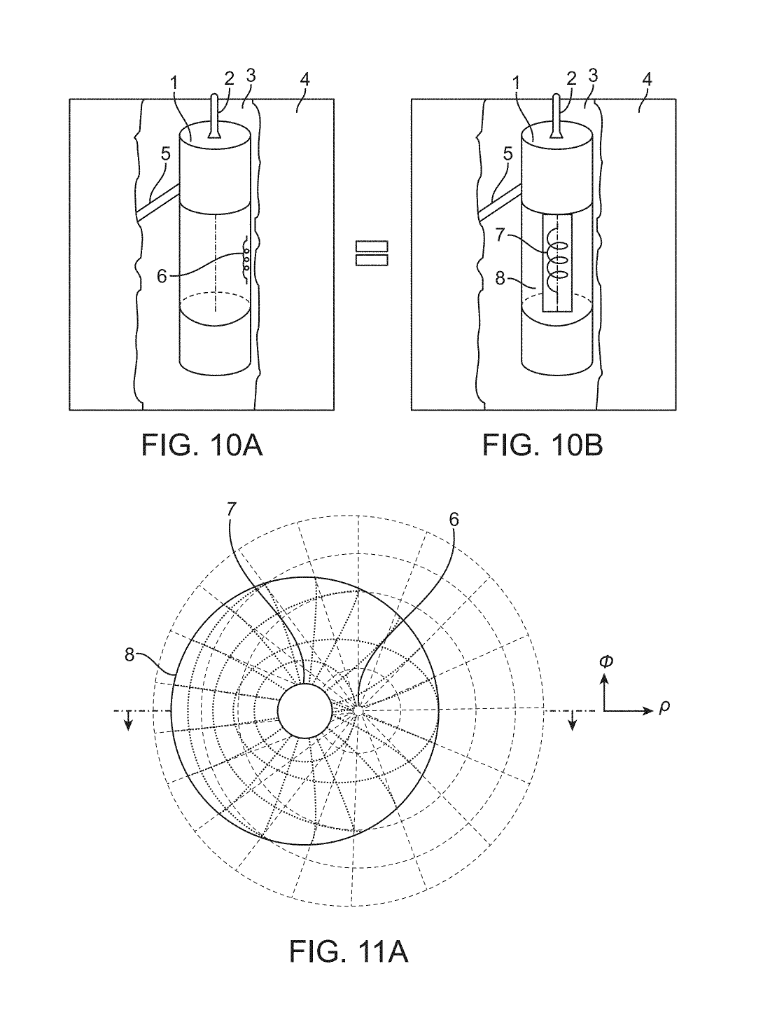

In yet another embodiment as shown in FIGS. 10A-10B, the metamaterial is used to downscale a larger concentric coil 7 to mimic a virtual smaller eccentric coil 6. The metamaterial downscales the coil 7 both radially and axially, and decentralizes the downscaled coil. Radial downscaling enables a stand-off smaller than the radius of the actual coil, whereas axial downscaling yields better vertical resolution than that achievable by the actual coil.

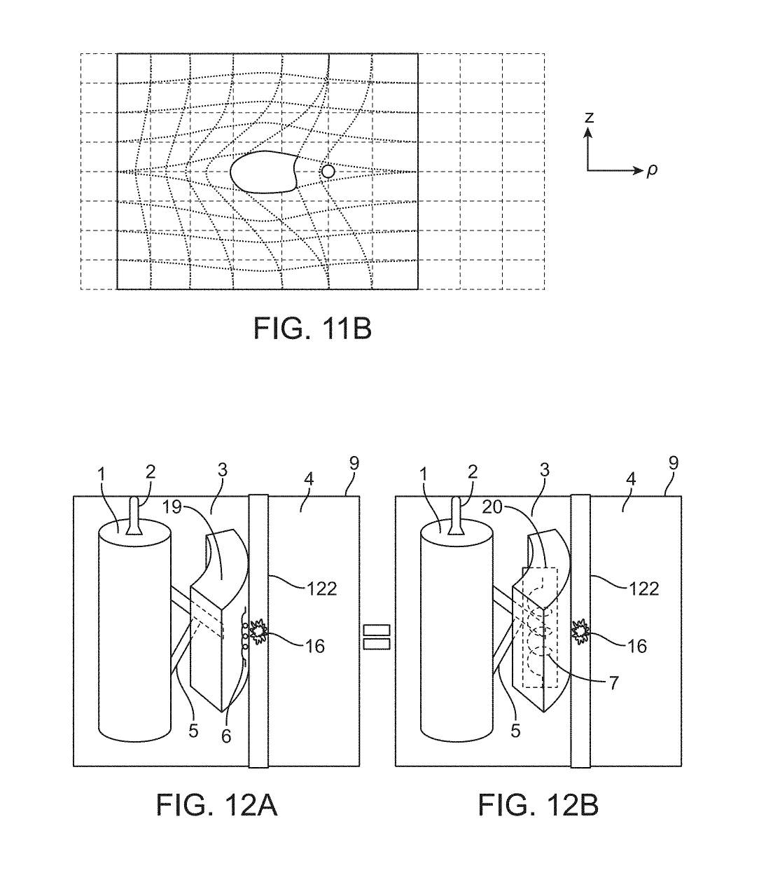

FIGS. 11A and 11B illustrate one possible coordinate transformation to achieve the combined downscaling/position shifting effect. It is to be noted that the point source at the center of the original (virtual) space is transformed into a finite-volume region in the transformed (actual) space. Any arbitrary sized source placed inside this finite-volume enclosure and surrounded by the proper transformation metamaterial will produce the identical fields outside the metamaterial as the (virtual) eccentric point source, thereby changing the effective location of the source.

FIGS. 12A and 12B illustrate a further embodiment of the disclosure in which the downscaling/position shifting transformation is applied to an azimuthal pipe or casing inspection tool. As shown in FIG. 12A, an ideal (virtual) design is to have a coil 6 in a dielectric pad 19 such that the coil 6 is adjacent to the wall of a borehole casing 9 in a borehole 3 and small enough to detect small faults 16 in the casing. Therefore, the effective location and size is altered in the ideal (virtual) design as compared to its actual location and size. The pad 19 is pressed against the wall 122 of the casing 9 by a deployable arm 5 connected to the tool body 1. As shown in FIG. 12B, the actual design uses a coil 7 which is of larger dimensions than the ideal coil 6, centrally embedded in a metamaterial pad 20. Therefore, the effective size of coil 7 is altered, and in particular, reduced as compared to its actual size. Moreover, the location of the coil 7 is also altered and shifted toward the borehole casing. Again, minimal stand-off between the coil 7 and the wall 122 and small coil height are desirable to resolve small faults in the casing under inspection. Appropriately designing the metamaterial pad in accordance with the transformation principles explained above will result in the actual coil 10 of FIG. 12B being mapped to the ideal (virtual) coil equivalent as shown in FIG. 12A.

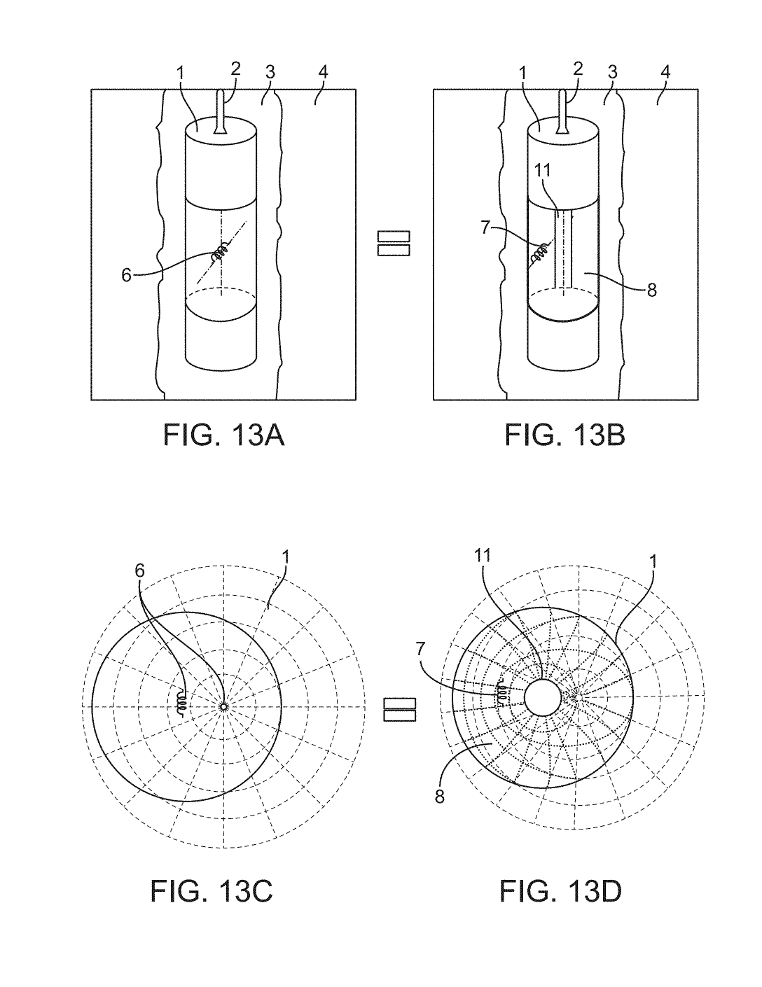

FIGS. 13A and 13B show another embodiment wherein the scaling-shifting transformation is used in an induction logging tool having a tool backbone 11 as shown in FIG. 13B, to effectively shift the location of an eccentric coil 7 to the center of the tool in place of the tool backbone 11, as shown in FIG. 13A as virtual coil 6. This is accomplished by embedding the tool backbone 11 in an appropriately designed metamaterial 8. The backbone 11 lies inside a finite-volume enclosure of the transformed grid, as shown in FIG. 13D, thereby transforming it to an infinitesimal eccentric line while the coil 7 is positioned so as to be shifted to be axially located in the tool. The resulting equivalent image is a centralized radial coil radiating in the presence of an infinitesimally thin eccentric backbone, as shown in FIG. 13C.

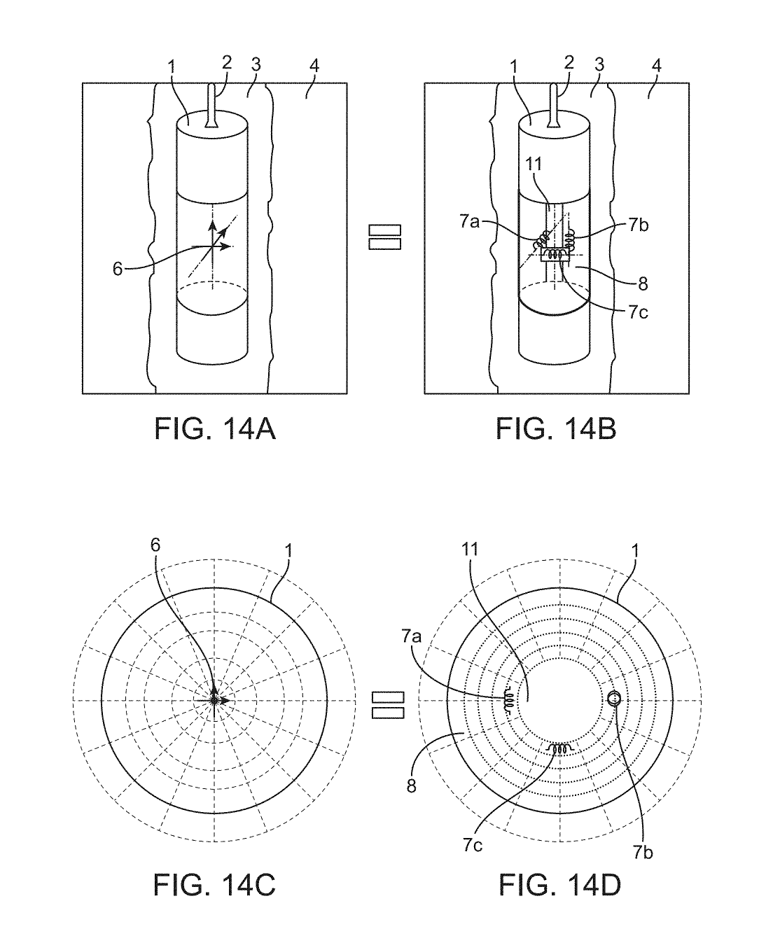

FIGS. 14A and 14B show yet another embodiment of an induction logging tool in which a virtual centralized triaxial coil 6 (FIG. 14A) is realized using three decentralized coils 7a, 7b, 7c embedded in a position-shifting metamaterial 8 (FIG. 14B). Again, the tool backbone 11 is effectively shrunk to an infinitesimal line by being placed in an enclosure within the metamaterial. The metamaterial further effectively co-locates the three coils 7a, 7b, 7c at a single point on the tool axis, thus changing their effective locations, as shown in FIG. 14A. Thus, while conventional triaxial coils consist of three electrically coupled pairs of orthogonal coils, the use of a metamaterial enables the realization of a triaxial coil by using only three uncoupled orthogonal coils. FIGS. 14C and 14D illustrate the corresponding grid transformations.

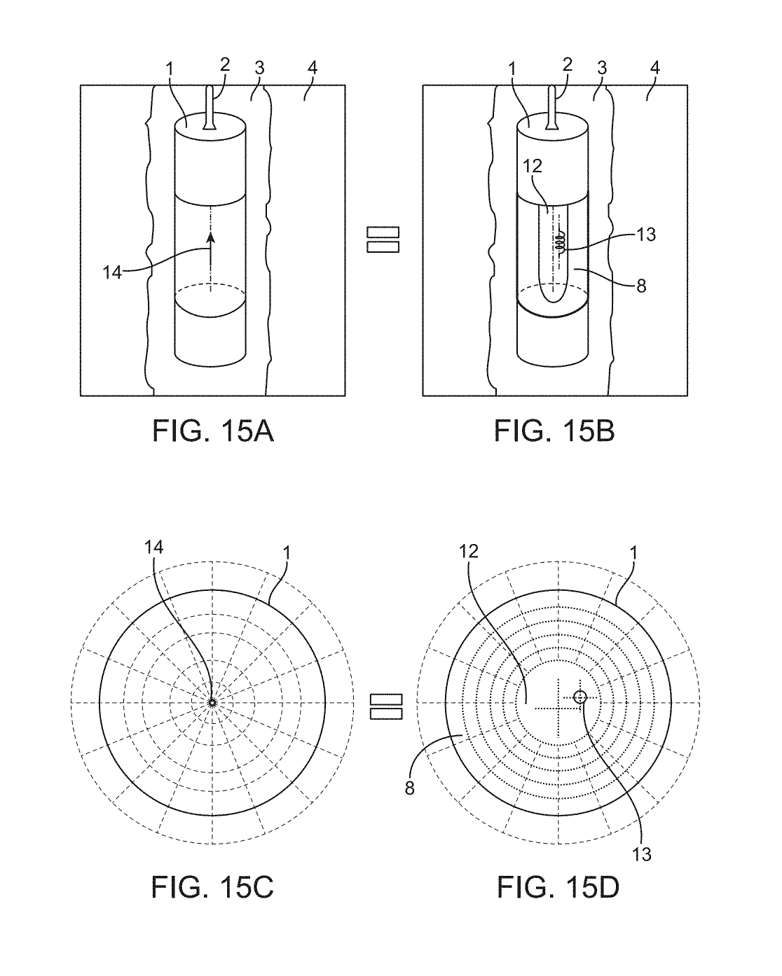

FIGS. 15A and 15B illustrate an embodiment in which the same metamaterial 8 of FIG. 14B is used to create a position-independent source space 12. Any source 13 placed at an arbitrary position within the enclosure 12 effectively collapses to an effective centralized point source 14 as shown in FIG. 15A, as a result of the coordinate transformation achieved by the metamaterial 8. The moment of the effective point source 14 is dependent upon the position of the actual source 13 inside the enclosure 12, which can be easily calibrated. This embodiment is important for applications where accurate placement and maintenance of source position with respect to the tool body 1 is required. FIGS. 15C and 15D illustrate the corresponding grid transformation.

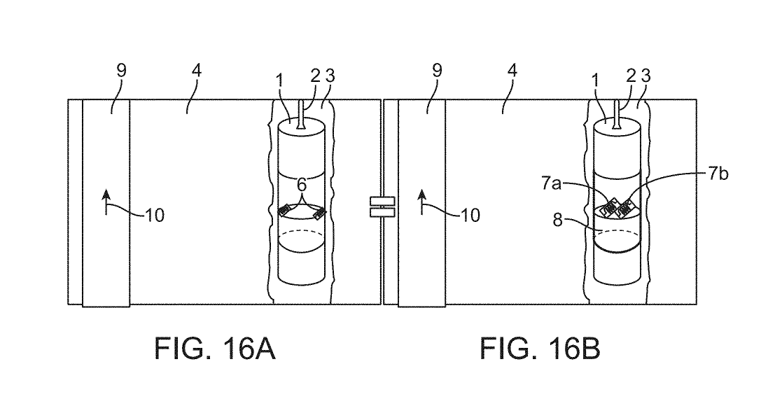

FIGS. 16A and 16B illustrate an embodiment of the disclosure relating to a gradient ranging tool. In such a tool having a tool body 1, two coils 7a, 7b are used to measure the azimuthal magnetic field that is generated by a current-carrying casing 9. In the figures, current is represented by arrow 10. The casing is embedded in a formation 4. The tool body 1 is placed in a ranging borehole 3 substantially parallel to the casing 9 in formation 4. The outputs of the coils 7a, 7b are differenced to compute the magnetic field gradient. To increase the stability of the gradient measurement in the presence of measurement noise/errors, it is desirable to maximize the spacing between the two coils (or aperture spanned by the two coils). This is shown in FIG. 16A as coils 6. However, the maximum attainable spacing within a given tool is determined by the size of the coils. This limitation is alleviated by embedding coils 7a, 7b as shown in FIG. 16B in a two-enclosure size scaling/position shifting metamaterial 8, which effectively shrinks the coils in size and shifts their effective location along opposite sides of the tool perimeter.

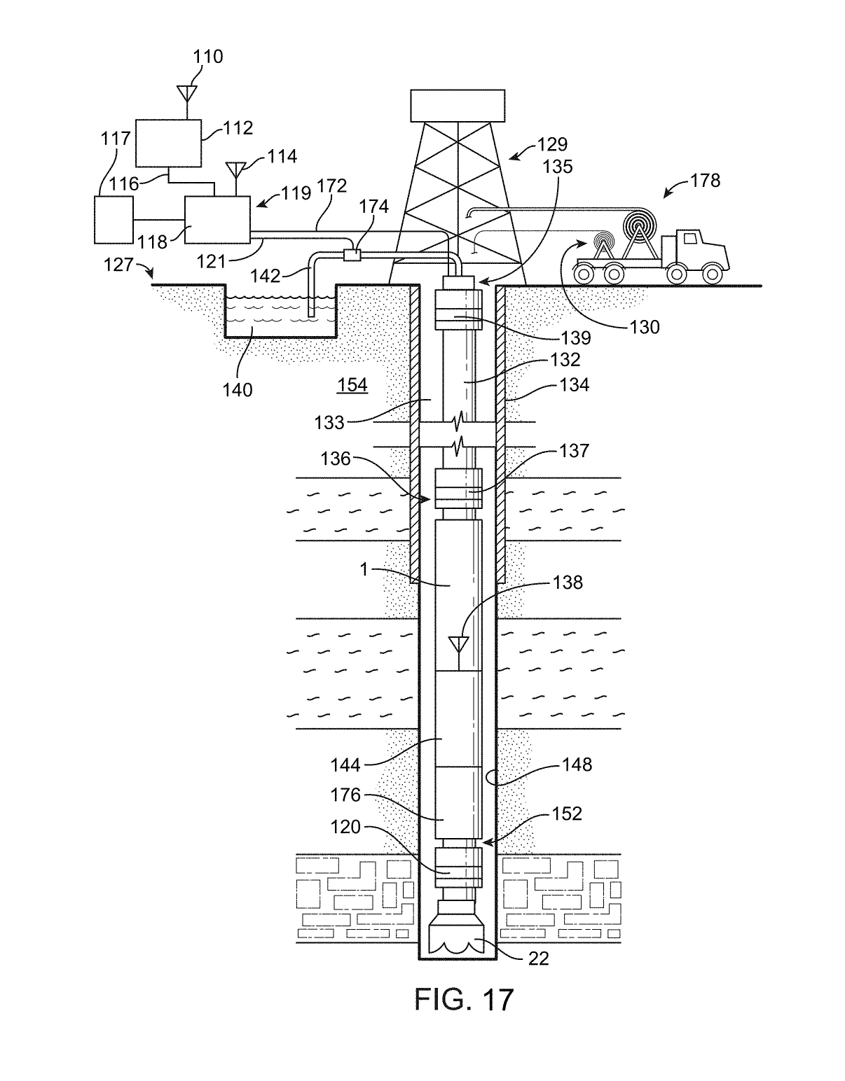

As noted above, and illustrated in FIG. 17, in a working environment the tool having a tool body 1 can be used in part of a drilling, logging or other operation where the tool is used downhole. A wellbore 148 is shown that has been drilled into the earth 154 from the ground's surface 127 using a drill bit 22. The drill bit 22 is located at the bottom, distal end of the drill string 132 and the bit 22 and drill string 132 are being advanced into the earth 154 by the drilling rig 129. The drilling rig 129 can be supported directly on land as shown or on an intermediate platform if at sea. For illustrative purposes, the top portion of the well bore includes casing 134 that is typically at least partially comprised of cement and which defines and stabilizes the wellbore after being drilled.

As shown in FIG. 17, the drill string 132 supports several components along its length. A sensor sub-unit 152 is shown for detecting conditions near the drill bit 22, conditions which can include such properties as formation fluid density, temperature and pressure, and azimuthal orientation of the drill bit 22 or string 132. In the case of directional drilling, measurement while drilling (MWD)/logging while drilling (LWD) procedures are supported both structurally and communicatively. The instance of directional drilling is illustrated in FIG. 17. The tool body 1 may also be deployed by wireline conveyance 130 or coiled tubing 178 as an independent service up removal of drill string 132 (wireline conveyance 130 further illustrated in FIG. 18 as discussed below).

In the example of FIG. 17, the lower end portion of the drill string 132 can include a drill collar proximate the drilling bit 22 and a rotary steerable drilling device 120. The drill bit 22 may take the form of a roller cone bit or fixed cutter bit or any other type of bit known in the art. The sensor sub-unit 152 is located in or proximate to the rotary steerable drilling device 120 and advantageously detects the azimuthal orientation of the rotary steerable drilling device 120. Other sensor sub-units 135, 136 are shown within the cased portion of the well which can be enabled to sense nearby characteristics and conditions of the drill string, formation fluid, casing and surrounding formation. Regardless of which conditions or characteristics are sensed, data indicative of those conditions and characteristics is either recorded downhole, for instance at the processor 144 for later download, or communicated to the surface either by wire using repeaters 137,139 up to surface wire 172, or wirelessly or otherwise. If wirelessly, the downhole transceiver (antenna) 138 can be utilized to send data to a local processor 18, via topside transceiver (antenna) 114. There the data may be either processed or further transmitted along to a remote processor 112 via wire 116 or wirelessly via antennae 114 and 110.

The possibility of an additional mode of communication is contemplated using drilling mud 140 that is pumped via conduit 142 to a downhole mud motor 176. The drilling mud is circulated down through the drill string 132 and up the annulus 133 around the drill string 132 to cool the drill bit 22 and remove cuttings from the wellbore 148. For purposes of communication, resistance to the incoming flow of mud can be modulated downhole to send backpressure pulses up to the surface for detection at sensor 174, and from which representative data is sent along communication channel 121 (wired or wirelessly) to one or more processors 118, 112 for recordation and/or processing.

The sensor sub-unit 152 is located along the drill string 132 above the drill bit 22. The sensor sub-unit 136 is shown in FIG. 17 positioned above the mud motor 176 that rotates the drill bit 22. Additional sensor sub-units 135, 136 can be included as desired in the drill string 132. The sub-unit 152 positioned below the motor 176 communicates with the sub-unit 136 in order to relay information to the surface 127.

A surface installation 119 is shown that sends and receives data to and from the well. The surface installation 119 can exemplarily include a local processor 118 that can optionally communicate with one or more remote processors 112, 117 by wire 116 or wirelessly using transceivers 110, 114.

In alternative examples, due to increased power requirements, or desire for reduced vibration resulting from a drill string, or other reasons, the tool having tool body 1 can be employed with “wireline” systems as illustrated in FIG. 18 in order to carry out logging or other operations. For example, instead of using the drill string 132 of FIG. 17 to lower tool body 1, it can be lowered into the wellbore 148 by wireline conveyance 130 as shown in FIG. 18. The wireline conveyance 130 can be anchored in the drill rig 129 or portable means such as a truck. The wireline conveyance 130 can be one or more wires, cables, or the like. The illustrated wireline conveyance 130 provides support for the tool, as well as enabling communication between the tool processors on the surface and providing a power supply. For example, the wireline conveyance 130 is sufficiently strong and flexible to tether the tool body 1 through the wellbore 148, while also permitting communication through the wireline conveyance 130 to local processor 118 and/or remote processors 112, 117. Additionally, power can be supplied via the wireline conveyance 130 to meet power requirements of the tool.

Further, as discussed above with respect to FIGS. 7-16, the tool body 1 is depicted as being deployed on a conveyance 2, which may include the wireline conveyance 130 shown in FIG. 18. Accordingly, logging operations can be conducted by the tool body 1 via wireline in accordance with the disclosure herein.

Numerous examples are provided herein to enhance understanding of the present disclosure. A specific set of examples are provided as follows. In a first example, there is disclosed herein a well logging tool, including a tool body (1); at least one electromagnetic sensor (7) with the tool body; a metamaterial (8) coupled to the tool body and the electromagnetic sensor that alters at least one of an effective location and an effective size of the sensor (7) with respect to the tool body (1).

In a second example, there is disclosed herein a method according to the first example wherein the electromagnetic sensor (7) is embedded in the metamaterial (8).

In a third example, there is disclosed herein a method according to the first or second examples, wherein the electromagnetic sensor (7) is outside the metamaterial (8).

In a fourth example, there is disclosed herein a method according to any of the preceding examples first to the third, wherein the electromagnetic sensor (7) is physically located along a central axis of the tool.

In a fifth example, there is disclosed herein a method according to any of the preceding examples first to the fourth, wherein the metamaterial (8) is designed to position shift the electromagnetic sensor (7) towards a periphery of the tool body (1).

In a sixth example, there is disclosed herein a method according to any of the preceding examples first to the fifth, wherein the electromagnetic sensor (7) is physically located away from a central axis of the tool (1).

In a seventh example, there is disclosed herein a method according to any of the preceding examples first to the sixth, wherein the metamaterial (8) is designed to position shift the electromagnetic sensor (7) towards a center of the tool body (1).

In an eighth example, there is disclosed herein a method according to any of the preceding examples first to the seventh, wherein the metamaterial (8) is embedded in the tool body (1).

In a ninth example, there is disclosed herein a method according to any of the preceding examples first to the eighth, wherein the metamaterial (8) is coupled to the tool via a deployable arm (5).

In a tenth example, there is disclosed herein a method according to any of the preceding examples first to the ninth, further including at least a second electromagnetic sensor (7a) coupled to the metamaterial (8), where the first electromagnetic sensor (7) is position shifted to a first position, and the second electromagnetic sensor (7a) is position shifted to the first or to the second position.

In an eleventh example, there is disclosed herein a method according to any of the preceding examples first to the tenth, where the third electromagnetic sensor (7b) is position shifted to the first, to the second, or to a third position.

In a twelfth example, there is disclosed herein a method according to any of the preceding examples first to the eleventh, wherein the electromagnetic sensors (7) comprise a triaxial coil.

In a thirteenth example, there is disclosed herein a method according to any of the preceding examples first to the twelfth, wherein the metamaterial (8) is designed to shrink the effective size of the electromagnetic sensor (7).

In a fourteenth example, there is disclosed herein a method according to any of the preceding examples first to the thirteenth, wherein the electromagnetic sensor (7) comprises a coil.

In a fifteenth example, there is disclosed herein a method according to any of the preceding examples first to the fourteenth, wherein the electromagnetic sensor (7) comprises a coil.

In a sixteenth example, there is disclosed herein a method of designing a well logging tool, including: constructing a metamaterial (8) having unit cells in a configuration providing at least one of a position-shifting function with respect to electromagnetic radiation passing through the metamaterial (8), and a size-shrinking function with respect to an electromagnetic sensor (7); locating the electromagnetic sensor (7) in operative relationship with the constructed metamaterial (8); and providing the electromagnetic sensor (7) and metamaterial (8) in a tool body (1).

In a seventeenth example, there is disclosed herein a method according to the sixteenth, further comprising constructing the metamaterial (8) having unit cells in a configuration providing size scaling of said electromagnetic sensor (7).

In an eighteenth example, there is disclosed herein a method according to the sixteenth or seventeenth examples, wherein the metamaterial (8) is designed to position-shift the effective location of the electromagnetic sensor (7) towards a periphery of the tool body (1).

In a nineteenth example, there is disclosed herein a method according to any of the examples from the sixteenth to the eighteenth, wherein the electromagnetic sensor (7) is embedded in the metamaterial (8).

In a twentieth example, there is disclosed herein A method of designing a well logging tool, including: constructing a metamaterial (8) having unit cells in a configuration providing a size-shrinking function with respect to an electromagnetic sensor (7); locating the electromagnetic sensor (7) in operative relationship with the constructed metamaterial (8); and providing the electromagnetic sensor (7) and metamaterial (8) in a tool body (1).

The metamaterials disclosed in the present disclosure can be designed according to the transformation optics rules disclosed in detail above. In general, these transformation optics rules are described by inhomogeneous anisotropic permittivity and permeability tensors, whose values lie within the range of electromagnetic frequencies used in operation of such measurement tools.

The embodiments shown and described above are only examples. Many details are often found in the art such as the other features of a logging system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A well logging tool, comprising:
a tool body;
at least one electromagnetic sensor coupled to the tool body;
a metamaterial coupled to the tool body and the electromagnetic sensor that alters at least one of an effective location and an effective size of the sensor with respect to the tool body.

2. The well logging tool of claim 1, wherein the electromagnetic sensor is embedded in the metamaterial.

3. The well logging tool of claim 1, wherein the electromagnetic sensor is outside the metamaterial.

4. The well logging tool of claim 1, wherein the electromagnetic sensor is physically located along a central axis of the tool.

5. The well logging tool of claim 4, wherein the metamaterial is designed to position shift the electromagnetic sensor towards a periphery of the tool body.

6. The well logging tool of claim 1, wherein the electromagnetic sensor is physically located away from a central axis of the tool.

7. The well logging tool of claim 6, wherein the metamaterial is designed to position shift the electromagnetic sensor towards a center of the tool body.

8. The well logging tool of claim 1, wherein the metamaterial is embedded in the tool body.

9. The well logging tool of claim 1, wherein the metamaterial is coupled to the tool via a deployable arm.

10. The well logging tool of claim 1, further comprising at least a second electromagnetic sensor coupled to the metamaterial, where the first electromagnetic sensor is position shifted to a first position, and the second electromagnetic sensor is position shifted to the first or to the second position.

11. The well logging tool of claim 10, further comprising at least a third electromagnetic sensor coupled to the metamaterial, where the third electromagnetic sensor is position shifted to the first, to the second, or to a third position.

12. The well logging tool of claim 11, wherein the electromagnetic sensors comprise a triaxial coil.

13. The well logging tool of claim 1, wherein the metamaterial is designed to shrink the effective size of the electromagnetic sensor.

14. The well logging tool of claim 13, wherein the electromagnetic sensor comprises a coil.

15. The well logging tool of claim 1, wherein the electromagnetic sensor comprises a coil.

16. A method of designing a well logging tool, comprising:
constructing a metamaterial having unit cells in a configuration providing at least one of a position-shifting function with respect to electromagnetic radiation passing through the metamaterial, and a size-shrinking function with respect to an electromagnetic sensor;
locating the electromagnetic sensor in operative relationship with the constructed metamaterial; and
providing the electromagnetic sensor and metamaterial in a tool body.

17. The method of claim 16, further comprising constructing the metamaterial having unit cells in a configuration providing size scaling of said electromagnetic sensor.

18. The method of claim 16, wherein the metamaterial is designed to position-shift the effective location of the electromagnetic sensor towards a periphery of the tool body.

19. The method of claim 16, wherein the electromagnetic sensor is embedded in the metamaterial.

20. A method of designing a well logging tool, comprising:
constructing a metamaterial having unit cells in a configuration providing a size-shrinking function with respect to an electromagnetic sensor;
locating the electromagnetic sensor in operative relationship with the constructed metamaterial; and
providing the electromagnetic sensor and metamaterial in a tool body.

21. The well logging tool of claim 1, wherein the electromagnetic sensor comprises a plurality of orthogonally disposed uncoupled coils.

22. The well logging tool of claim 1, wherein the metamaterial is located in a moveable pad which is coupled to the tool.
